(19) United States
(12) Patent Application Publication
(10) Pub. No.: US 2019/0188624 A1
(43) Pub. Date: Jun. 20, 2019

(54) AUTOMATED ONE-TO-MANY SCHEDULING OF INTERVIEWS WITH CANDIDATES

(71) Applicant: Microsoft Technology Licensing, LLC, Redmond, WA (US)

(72) Inventors: Wai Lim W. Pong, San Jose, CA (US); Li Zhou, Sunnyvale, CA (US); Wei Luo, Union City, CA (US)

(73) Assignee: Microsoft Technology Licensing, LLC, Redmond, WA (US)

(21) Appl. No.: 15/844,887

(22) Filed: Dec. 18, 2017

(51) Int. Cl. G06Q 10/06; G06Q 10/10

(52) U.S. Cl. CPC G06Q 10/063112; G06Q 10/1053

(57) ABSTRACT

The disclosed embodiments provide a system for processing data. During operation, the system obtains, for a set of interviews with a candidate, a set of constraints that includes availabilities of a set of interviewers, a set of available time slots, and a time period spanned by the set of interviews. Next, the system generates, using the set of constraints, an interview schedule that includes an assignment of the set of interviewers to a subset of the available time slots in the time period by sequentially matching each time slot in the subset of the available time slots to the availabilities of the set of interviewers. The system then schedules the set of interviews according to the interview schedule.

### BACKGROUND

### Field

The disclosed embodiments relate to screening of candidates. More specifically, the disclosed embodiments relate to techniques for performing automated one-to-many scheduling of interviews with candidates.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a flowchart illustrating a process of generating an interview schedule containing interviews between a set of interviewers and a candidate in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

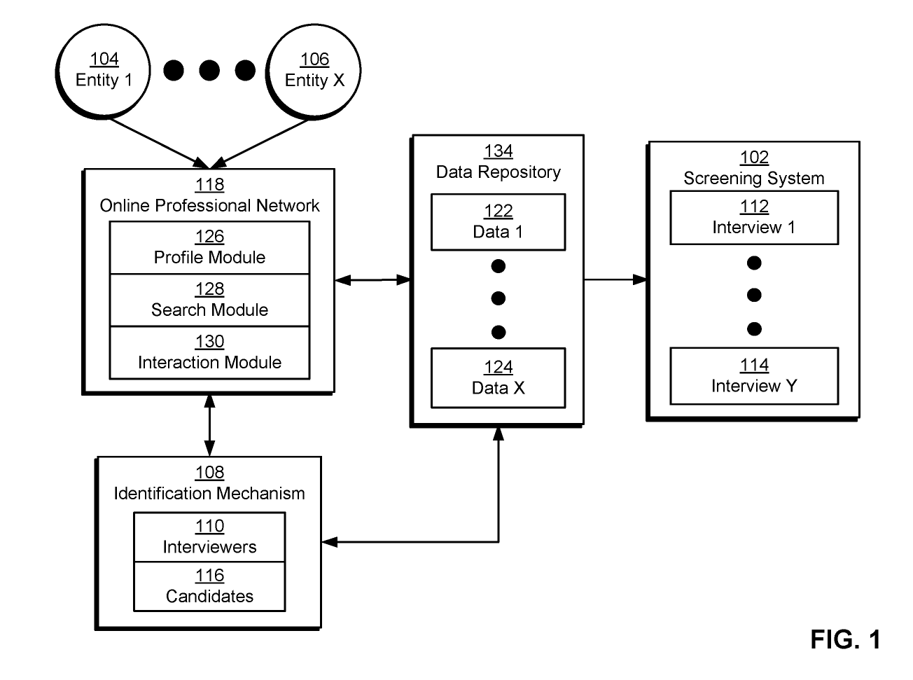

The disclosed embodiments provide a method, apparatus, and system for performing automated one-to-many scheduling of interviews with candidates. As shown in FIG. 1, screening or interviewing of candidates may involve members of a social network or other community, such as an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

In turn, member profiles and/or activity with online professional network 118 are used by a screening system 102 to automatically schedule, track, and/or manage interviews (e.g., interview 1 112, interview y 114) for jobs, positions, roles, and/or opportunities that are listed within or outside online professional network 118. For example, screening system 102 may be used by recruiters, managers, human resources professionals, and/or other “moderators” involved in filling the jobs, positions, roles, and/or opportunities to manage, schedule, and/or track phone screen interviews, onsite interviews, auditions, and/or other types of interviews or interaction related to screening candidates 116 for the jobs, positions, roles, and/or opportunities. Because screening system 102 is coupled to and/or included in online professional network 118, screening system 102 allows the moderators to leverage professional qualifications and/or other online professional network 118 data to select interviewers 110 for participating in the interviews.

As shown in FIG. 1, interviewers 110 and candidates 116 (e.g., job candidates) participating in the interviews may be identified by an identification mechanism 108 using data from data repository 134 and/or online professional network 118. First, identification mechanism 108 may identify candidates 116 as users who have applied to jobs, positions, roles, and/or opportunities, within or outside online professional network 118. Identification mechanism 108 may also, or instead, identify candidates 116 as users and/or members of online professional network 118 with skills, work experience, and/or other attributes or qualifications that match the corresponding jobs, positions, roles, and/or opportunities.

Second, identification mechanism 108 may identify interviewers 110 as members of online professional network 118 and/or other users who have registered with screening system 102 to conduct interviews. Interviewers 110 may additionally or alternatively include users that are identified by identification mechanism 108 as having skills, experience, reputations, recommendations, and/or other qualifications for conducting interviews for the corresponding jobs, positions, roles, and/or opportunities.

Identification mechanism 108 and/or another component of the system may also include functionality to obtain user input for specifying interviewers 110, candidates 116, and/or other entities participating in interviews managed through screening system 102. For example, the component may include a user interface that allows a recruiter, sourcer, hiring manager, human resources professional, and/or other moderator involved in screening for and/or placing jobs, positions, roles, and/or opportunities to select one or more candidates 116, interviewers 110, and/or interviews for the jobs, positions, roles, and/or opportunities.

In one or more embodiments, screening system 102 uses online professional network 118 data and/or a set of constraints to automatically schedule one-to-many interviews between a single candidate and multiple interviewers 110. Such one-to-many interviews may include panel interviews, back-to-back interviews spanning one or more days, and/or other types of interviews involving multiple interviewers 110 over a given time period. As described in further detail below, screening system 102 may use profile and/or activity data with online professional network 118 to identify interviewers 110 that are qualified, available, reputable, and/or otherwise suitable for conducting the corresponding interviews.

Screening system 102 then automatically generates interview schedules containing assignments of interviewers 110 to available time slots within the time period. After a given interview schedule is selected and/or confirmed by a moderator, screening system 102 may schedule the interviews in the interview schedule, track responses to invitations for the scheduled interviews, and/or modify the interview schedule based on the responses. Consequently, screening system 102 may reduce overhead associated with manually scheduling interviews, increase the quality of interviewers 110 and/or interviews for opportunities associated with companies or organizations of various sizes, and/or streamline the screening process for moderators, interviewers 110, candidates 116, and/or other entities affected by the interviews.

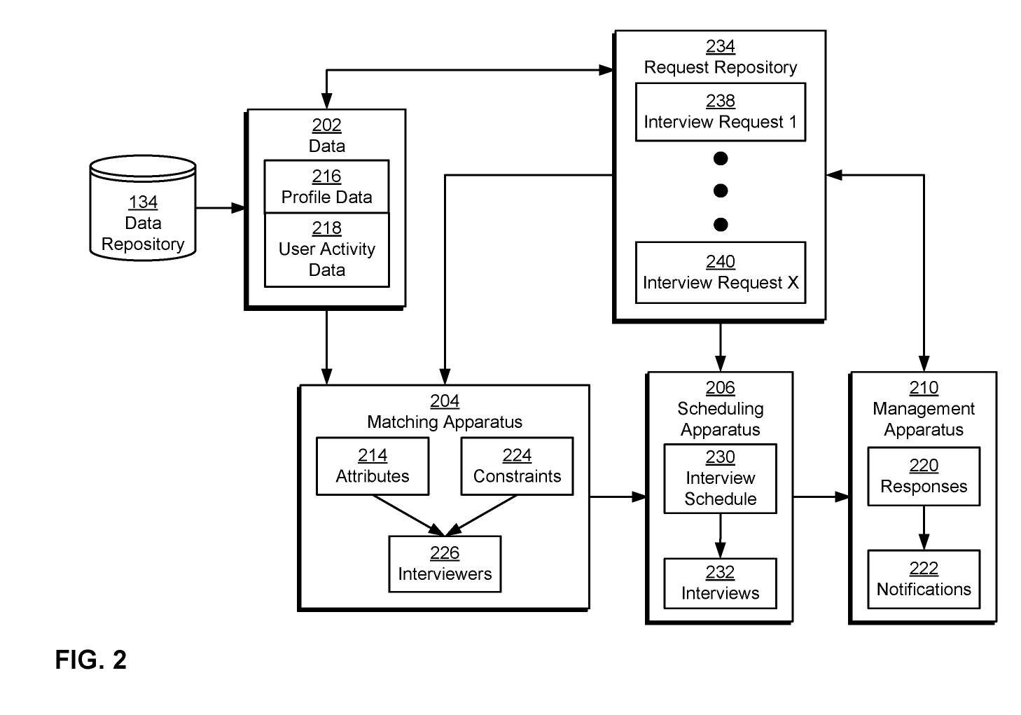

FIG. 2 shows a system for processing data in accordance with the disclosed embodiments. More specifically, FIG. 2 shows a system for performing automated one-to-many scheduling of interviews with candidates, such as screening system 102 of FIG. 1. The system includes a matching apparatus 204, a scheduling apparatus 206, and a management apparatus 210. Each of these components is described in further detail below.

As shown in FIG. 2, the system utilizes data 202 from data repository 134, which includes profile data 216 for members of a social network or other community of users (e.g., online professional network 118 of FIG. 1), as well as user activity data 218 that tracks the members' activity within and/or outside the social network. Profile data 216 may include data associated with member profiles in the social network. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, patents or publications associated with the user, and/or other data related to the user's interaction with the social network.

Attributes of the members may be matched to a number of member segments, with each member segment containing a group of members that share one or more common attributes. For example, member segments in the social network may be defined to include members with the same industry, title, location, and/or language.

Connection information in profile data 216 may additionally be combined into a graph, with nodes in the graph representing entities (e.g., users, schools, companies, locations, etc.) in the social network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 may include records of member interactions with one another and/or content associated with the social network. For example, user activity data 218 may be used to track impressions, clicks, likes, dislikes, shares, hides, comments, posts, updates, conversions, and/or other user interaction with content in the social network. User activity data 218 may also, or instead, track other types of social network activity, including connections, messages, job applications, and/or interaction with groups or events. User activity data 218 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 may additionally include schedules, calendars, and/or upcoming availabilities of the users, which may be used to schedule meetings, interviews, and/or events for the users. Like profile data 216, user activity data 218 may be used to create a graph, with nodes in the graph representing social network members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

Profile data 216, user activity data 218, and/or other data in data repository 134 may be standardized before the data is used by components of the system. For example, skills in profile data 216 may be organized into a hierarchical taxonomy that is stored in data repository 134 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In one or more embodiments, the system of FIG. 2 uses profile data 216 and/or user activity data 218 to automatically generate an interview schedule 230 containing an ordered set of interviews 232 involving multiple interviewers 226 and a single candidate. Interviews 232 may be conducted in response to an interview request (e.g., interview request 1 238, interview request x 240) from a “moderator” such as a recruiter, hiring manager, human resources professional, executive, coordinator, and/or other entity involved in filling a job or position at a company, school, group, and/or organization.

For example, each interview request may be generated by a moderator through a user interface provided by the system and/or over email, phone, text, messaging, and/or another communications mechanism. The interview request may include a job title, job description, skills, experience, and/or other characteristics of a job to be filled. The interview request may additionally include constraints 224 associated with interviews 232 to be conducted with a candidate for the job. After the interview request is submitted, the interview request may be stored in a request repository 234, which may include a relational database, distributed filesystem, data warehouse, cloud storage, and/or other data-storage mechanism.

In turn, matching apparatus 204 uses the interview request to identify a set of interviewers 226 for conducting interviews 232. As mentioned above, a set of constraints 224 may be specified in the interview request. For example, constraints 224 may include potential days and/or time periods (e.g., Monday 10 am to 5 pm, Wednesday 9 am to 3 pm, Friday from noon to 6 pm) over which interviews 232 can take place, the number of interviews 232 to conduct over one or more time periods, the duration of each interview, and/or available time slots for interviews 232 (e.g., 30- to 60-minute time slots within an eight hour time period with a one-hour break for lunch). Constraints 224 may also include a list of required and/or optional interviewers 226, a partial or full ordering of interviewers 226 within an interview schedule 230 to be generated by the system, priorities associated with interviewers 226 (e.g., required, optional, high-priority, medium priority, low priority, etc.), and/or other parameters associated with scheduling interviews 232 with a known or identified set of interviewers 226.

Constraints 224 may further specify attributes 214 of interviewers 226 that are qualified to conduct interviews 232, in addition to or in lieu of a list of specific interviewers 226 or potential interviewers 226 to be included in interview schedule 230. For example, interviewer-related constraints 224 for a series of job interviews with a single candidate may include skills, job titles, seniorities, work experience, education, interview experience, reputation scores, locations, and/or other professional or other qualifications of interviewers 226. In another example, interviewer-related constraints 224 may specify schools, companies, locations, and/or other attributes that are used to exclude one or more potential interviewers 226 from interview schedule 230.

Constraints 224 may additionally specify resources to be used in conducting one or more interviews 232. For example, constraints 224 may include conference rooms of a certain size, computers, projectors, and/or other interviewing tools to be used with interviews 232.

As mentioned above, interviewers 226 may include members of an online professional network (e.g., online professional network 118 of FIG. 1) and/or other users who have registered as interviewers with the screening system. Interviewers 226 may also, or instead, include users who are identified as qualified for conducting certain types of interviews (e.g., technical interviews, screenings for culture, screenings for leadership, scholarship interviews, fellowship interviews, auditions, etc.). As a result, interviewers 226 may be identified using online professional network profiles of the users; resumes of the users; public records; recommendations, endorsements, or other social validation of the users; and/or reviews or ratings of the historical interviewing performance of interviewers 226.

Consequently, interviewers 226 may be associated with attributes 214 such as profile data 216 and/or user activity data 218 that is used to assess the qualifications, availability, and/or suitability of interviewers 226 in conducting interviews 232. For example, attributes 214 may include employment, work experience, seniority, industry, title, education, skills, endorsements, recommendations, certifications, licenses, awards, accomplishments, and/or other self-reported and/or socially validated professional qualifications of interviewers 226. Attributes 214 may also include online professional network connections, schedules, and/or calendars of interviewers 226.

In one or more embodiments, matching apparatus 204 combines constraints 224 with attributes 214 to identify a set of potential and/or required interviewers 226 for conducting interviews 232. For example, matching apparatus 204 may obtain a partial or complete list of interviewers 226 from constraints 224 and/or the corresponding interview request. Matching apparatus 204 may also, or instead, generate a list of best-qualified interviewers 226 and/or filter interviewers 226 identified in the interview request and/or constraints 224 by matching interviewers 226 and their corresponding experiences, reputations, and/or other attributes 214 to qualifications (e.g., leadership, specific skills, collaboration, culture, etc.) specified in constraints 224. The list may include a pre-specified number of the best-qualified interviewers 226 (e.g., most qualified, top three most qualified, etc.) for a given set of qualifications and/or all interviewers 226 with qualifications that exceed a threshold. Matching apparatus 204 may further ensure that the identified interviewers 226 have availability that can accommodate time-based constraints 224 (e.g., time periods in which to conduct interviews 232, a deadline for completing interviews 232, available time slots for interviews 232, etc.).

Next, scheduling apparatus 206 generates, using constraints 224 and/or interviewers 226, an interview schedule 230 containing an ordered list of interviews 232 with the candidate. Interview schedule 230 may include an assignment of interviewers 226 to available time slots in a given time period, as specified in constraints 224. For example, scheduling apparatus 206 may schedule five one-hour interviews 232 within an eight-hour time period by matching one-hour time slots in the time period to available time slots for interviewers 226. Interviews 232 may also be scheduled with interviewers 226 that are required to interview the candidate and/or interviewers 232 that are capable of reviewing all required qualifications of the candidate. For example, scheduling apparatus 206 may assign one or more interviews 232 of the candidate with one or more required interviewers 226. Scheduling apparatus 206 may also, or instead, select an interviewer from a set of qualified interviewers 226 for conducting a specific type of interview and/or performing a certain type of screening and assign the interviewer to a time slot in interview schedule 230.

More specifically, scheduling apparatus 206 may generate interview schedule 230 by sequentially matching each available time slot in the time period to availabilities of interviewers 226 and selecting an interviewer with availability during the time slot. After a time slot is filled, scheduling apparatus 206 may proceed to the next time slot in the time period and assign the time slot to a different interviewer with availability during the time slot. For example, scheduling apparatus 206 may sequentially fill five time slots in the time period from earliest to latest by assigning each time slot to an interviewer that is available during the time slot.

Scheduling apparatus 206 may alternatively use non-temporal sequences of the time slots to sequentially match the time slots to interviewers 226. For example, scheduling apparatus 206 may sequentially iterate through interviewers 226 and match each interviewer to a time slot in which the interviewer is available. After a given interviewer is assigned to a time slot, scheduling apparatus 206 may proceed to the next interviewer and assign the interviewer to a time slot that is both free in the interviewer's schedule and has yet to be assigned to another interviewer.

After a given time slot is assigned to an interviewer, scheduling apparatus 206 may remove all constraints 224 associated with the time slot and/or interviewer (e.g., a requirement to schedule an interview in the time slot, one or more qualifications to screen for during interviews 232, a requirement to include the interviewer as a participant in interviews 232, etc.) from the set of remaining constraints 224 to be satisfied. In turn, scheduling apparatus 206 may schedule subsequent interviews 232 with interviewers 226 in a way that further reduces the remaining constraints 224.

For example, constraints 224 may include requirements that, interviews 232 include screenings for qualifications related to leadership, job-related skills, and culture. Interviewers 226 may include three people that are qualified to screen for leadership, two people that are qualified to screen for job-related skills, and one person that is qualified to screen for culture. As a result, scheduling apparatus 206 may schedule an interview with the only interviewer that can screen for culture, select from two interviewers 226 to schedule an interview that screens for job-related skills, and select from three interviewers 226 to schedule an interview that screens for leadership. Once a given time slot is assigned to an interviewer that fulfills a given screening requirement (e.g., leadership, job-related skills, culture), scheduling apparatus 206 may assign remaining time slots in the time period to interviewers 226 that fulfill other screening requirements and/or are otherwise participating in interviews 232.

In another example, constraints 224 may include a partial or full ordering of interviewers 232. As a result, scheduling apparatus 206 may generate interview schedule 230 so that interviewers 226 that are earlier in the ordering are assigned to earlier time slots than interviewers 226 that are later in the ordering. If an interviewer is not included in the ordering but identified as a participant in interviews 232, scheduling apparatus 206 may assign the interviewer to a time slot that both meets the interviewer's availability and does not violate the ordering (e.g., by including the interviewer in a middle time slot when the ordering specifies a first interviewer and a last interviewer in interview schedule 230).

In a third example, constraints 224 may include low, medium, and/or high priorities associated with interviewers 232. Scheduling apparatus 206 may thus schedule interviews 232 with high-priority interviewers 232 before scheduling interviews 232 with medium-priority interviewers 226 and schedule interviews 232 with medium-priority interviewers 226 before scheduling interviews 232 with low-priority interviewers.

If scheduling apparatus 206 finds a time slot that cannot be assigned (e.g., because all remaining interviewers 226 are busy during the time slot) and remaining interviewers 226 and/or interviews 232 can be accommodated by remaining time slots in the time period, scheduling apparatus 206 may omit scheduling of an interview in the time slot. For example, scheduling apparatus 206 may skip a one-hour time slot in an eight-hour time period because six remaining one-hour time slots in the time period can be used to schedule four remaining interviews 232 in interview schedule 230. Instead, scheduling apparatus 206 may attempt to assign the next time slot to a remaining interviewer by matching the time slot to the availabilities of remaining interviewers 226 in interview schedule 230, as discussed above. Alternatively, scheduling apparatus 206 may be configured to schedule interviews 232 in back-to-back time slots to improve the interview experience for the candidate.

If scheduling apparatus 206 determines that remaining constraints 224 cannot be satisfied using the remaining time slots and/or interviewers 226, scheduling apparatus 206 discards all existing assignments of interviewers 226 to time slots and restarts the process of matching time slots in the time period to a new ordering of interviewers 226. For example, scheduling apparatus 206 may assign the first time slot in the time period to a different interviewer than the previously assigned interviewer and attempt to fill remaining time slots in the time period in a way that satisfies interviewer availabilities and/or other constraints 224. Thus, scheduling apparatus 206 may iteratively restart the sequential matching process of time slots to interviewers 226 until a valid interview schedule 230 that satisfies all constraints 224 is generated.

Scheduling apparatus 206 may similarly assign resources to interviews 232 based on the availability of the resources and/or associated constraints 224. For example, scheduling apparatus 206 may select a conference room as the location of a series of in-person interviews 232. If the conference room is unavailable for a given time slot, scheduling apparatus 206 may pick the closest available conference room as the location of the interview during the time slot. In another example, scheduling apparatus 206 may pick a room of a certain size to accommodate constraints 224 related to the number of participants in the corresponding interview. In a third example, scheduling apparatus 206 may pick a room with a projector and/or computer for an interview to allow the interviewer and/or candidate to participate in a certain type of interaction or activity (e.g., presentation, coding challenge, writing challenge, other computer-based interaction, etc.) during the interview.

Scheduling apparatus 206 may optionally generate multiple interview schedules that meet constraints 224. For example, scheduling apparatus 206 may identify, for a given time period (e.g., one day) specified in constraints 224, all valid interview schedules containing different assignments of interviewers to time slots in the time period and/or a pre-specified number (e.g., the first 3, 5, or 10) of valid interview schedules. If constraints 224 include multiple available time periods (e.g., multiple possible days for conducting interviews 230), scheduling apparatus 206 may generate all valid interview schedules for all time periods that can accommodate the availabilities of interviewers 226 that are required to attend interviews 230. In other words, scheduling apparatus 206 may employ a “brute force” technique to identify all valid interview schedules as permutations of assignments to interviewers 226 to time slots that satisfy constraints 224. Scheduling apparatus 206 and/or another component of the system may then output the valid interview schedules to a recruiter, hiring manager, human resources professional, executive, coordinator, and/or other moderator and obtain a selection of one of the interview schedules from the moderator. Alternatively, the component may automatically select one of the interview schedules on behalf of the moderator based on other criteria (e.g., a metric or value to optimize).

If scheduling apparatus 206 cannot find any valid interview schedules using constraints 224, attributes 214, and/or interviewers 226, scheduling apparatus 206 and/or another component of the system may generate a notification and/or other output that informs the moderator of a failure to generate interview schedule 230. In turn, the moderator may modify one or more constraints 224 and/or other parameters used to identify interviewers 226 and/or generate interview schedule 230, and matching apparatus 204 and scheduling apparatus 206 may attempt to generate interview schedule 230 using the modified constraints 224.

After a given interview schedule 230 is selected and/or confirmed by the moderator, scheduling apparatus 206 may schedule interviews 232 according to interview schedule 230. For example, scheduling apparatus 206 may create calendar events for interviews 232 and transmit invitations for the events to the corresponding interviewers 226. Scheduling apparatus 206 and/or another component of the system may optionally output interview schedule 230 as a list of time slots, interviewers and/or resources assigned to the time slots, and/or the type of each interview (e.g., technical interview, leadership screening, group interview, phone screen, etc.). The moderator may forward the outputted interview schedule 230 to the candidate, or the component may transmit the outputted interview schedule to the candidate on the moderator's behalf (e.g., in an email, notification, or other communication to the candidate).

After invitations to interviews 232 are transmitted to the corresponding interviewers 226, management apparatus 210 tracks responses 220 to the invitations from interviewers 226 and generates notifications 222 and/or other output based on responses 220. For example, management apparatus 210 may track each interviewer's acceptance, rejection, and/or lack of response to an invitation for an interview in interview schedule 230. If the interviewer rejects the invitation, management apparatus 210 may generate a notification to the moderator and provide options for replacing the interviewer with a similar interviewer, changing interview schedule 230, replacing interview schedule 230 with another valid interview schedule, and/or otherwise updating interview schedule 230 in response to the rejection. Management apparatus 210 may alternatively generate output for updating interview schedule 230 (e.g., by sending updated invitations to reflect changes in interview schedule 230) without requiring approval from the moderator. If the interviewer fails to respond to the invitation within a pre-specified period (e.g., a certain number of hours or days), management apparatus 210 may transmit a reminder to the interviewer. If the interviewer still fails to respond after a longer period, management apparatus 210 may handle the lack of response as a rejection of the invitation and generate output accordingly, as described above.

By leveraging professional network data to automatically arrange and/or manage job interviews, the system of FIG. 2 may allow recruiters, sourcers, managers, and/or other moderators of candidate screening processes to access potential interviewers 226 and/or interview resources in an automated and streamlined fashion, reduce manual overhead associated with selecting interviewers and/or lining up interviews, and ensure that interviewers 226 matched to interviews 232 have the requisite skills, experience, and/or background to assess the corresponding candidates. Consequently, the system may improve computer technologies related to recruiting, screening, scheduling, matching, and/or online networks, as well as user engagement, user experiences, and user interaction through the technologies and/or network-enabled devices or applications used to access the technologies.

Those skilled in the art will appreciate that the system of FIG. 2 may be implemented in a variety of ways. First, matching apparatus 204, scheduling apparatus 206, management apparatus 210, data repository 134, and request repository 234 may be provided by a single physical machine, multiple computer systems, one or more virtual machines, a grid, one or more databases, one or more filesystems, and/or a cloud computing system. Matching apparatus 204, scheduling apparatus 206, and management apparatus 210 may additionally be implemented together and/or separately by one or more hardware and/or software components and/or layers.

Second, the system of FIG. 2 may be adapted to various types of interviews, screenings, and/or interactions. As mentioned above, the system may be used to schedule panel interviews, group interviews, a sequence of interviews, and/or other types of interviews involving a single candidate and multiple interviewers 232. Along the same lines, the functionality of the system may be used with interviews, screenings, auditions, and/or other types of interactions with applicants or candidates for academic positions, artistic or musical roles, school admissions, fellowships, scholarships, competitions, club or group memberships, matchmaking, and/or other types of opportunities.

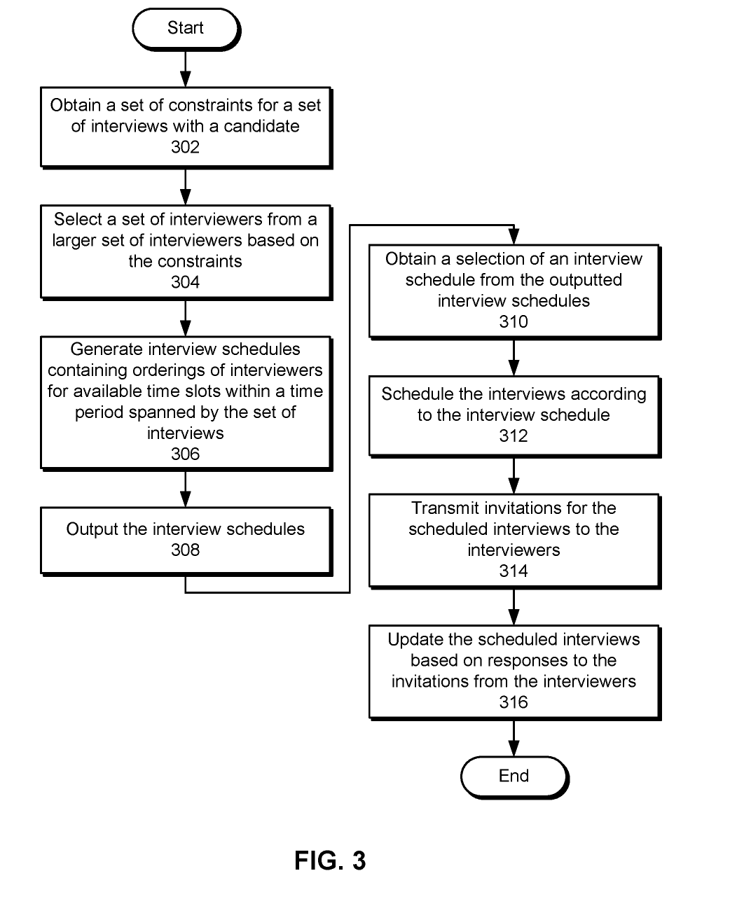

FIG. 3 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of constraints for a set of interviews with a candidate is obtained (operation 302). The interviews may include a panel interview, a series of interviews spanning a day, and/or other interview formats involving multiple interviewers and a single candidate. The constraints may include the availabilities of a set of interviewers, a set of available time slots, and/or a time period spanned by the set of interviews. The constraints may also, or instead, include a partial or full ordering of the interviewers, priorities associated with the interviewers, and/or interviewer attributes (e.g., skills, level of experience, work history, education, reputation scores, etc.) that are desired, required, and/or to be excluded. The constraints may further include an availability and/or use of a resource such as a conference room, projector, computer, and/or other interviewing tool.

Next, a set of interviewers is selected from a larger set of interviewers based on the constraints (operation 304). For example, the constraints may be used to identify interviewers that are available during the time period and/or before a deadline for completing the interviews, qualified to screen for certain skills and/or qualifications, and/or associated with high reputation scores and/or other external validation of the corresponding screening or interviewing abilities. Operation 304 may be omitted if a list of interviewers is included in the constraints.

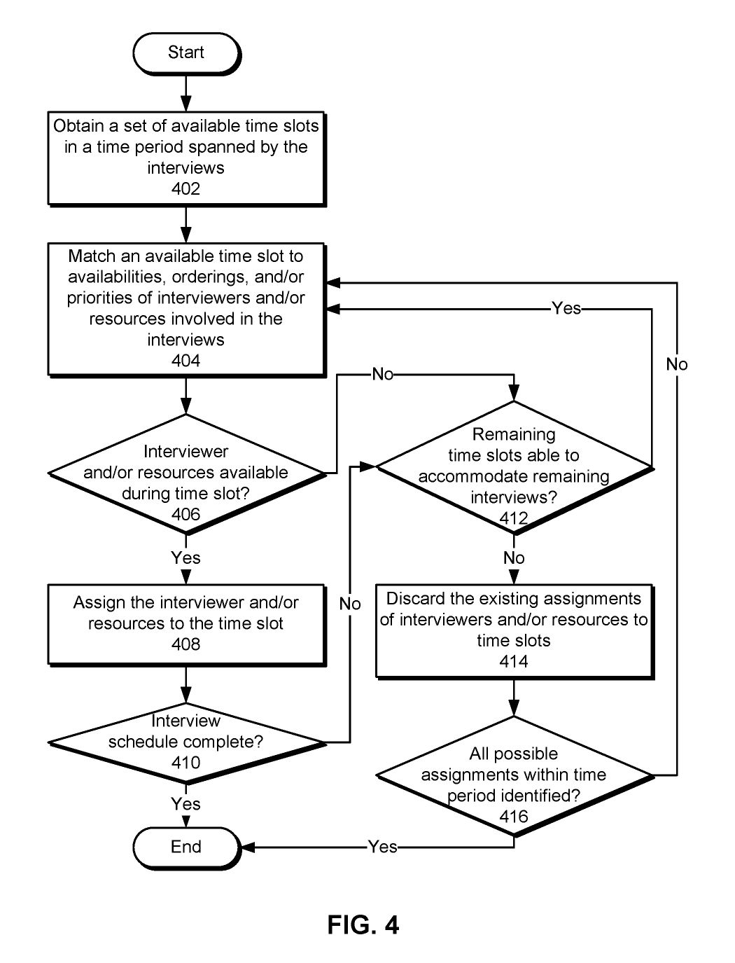

One or more interview schedules containing orderings of interviewers for available time slots within a time period spanned by the interviews are then generated (operation 306), as described in further detail below with respect to FIG. 4. After the interview schedules are generated, the interview schedules are outputted (operation 308), and a selection of an interview schedule from the outputted interview schedules is obtained (operation 310). For example, the interview schedules may be displayed and/or transmitted to a moderator of the interviews, and the moderator may generate input for selecting one of the interview schedules for use in conducting the interviews. Operations 308-310 may be omitted if only one interview schedule is generated and/or an interview schedule is selected automatically, on behalf of the moderator.

The interviews are scheduled according to the selected interview schedule (operation 312), and invitations for the scheduled interviews are transmitted to the corresponding interviewers (operation 314). For example, calendar events for the interviews may be created, and invitations to the calendar events and/or other notifications of the calendar events may be sent to the interviewers.

Finally, the scheduled interviews are updated based on responses to the invitations from the interviewers (operation 316). For example, output to modify the interview schedule may be generated when a response includes a rejection of an invitation for an interview. In another example, a reminder of an invitation may be generated when a response to the invitation is not received within a pre-specified period. In a third example, an acceptance of an invitation may be used to confirm the corresponding interview in the interview schedule. After all invitations have been accepted, the interview schedule may be confirmed with the moderator and/or provided to the candidate to allow all participants to be notified of the interview schedule.

FIG. 4 shows a flowchart illustrating a process of generating an interview schedule containing interviews between a set of interviewers and a candidate in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, a set of available time slots in a time period spanned by the interviews is obtained (operation 402). For example, a set of half-hour and/or one-hour time slots may be obtained from an eight-hour period in which the interviews are to be conducted. The time slots may exclude breaks, lunch periods, and/or other times in which the interviews are not to be scheduled.

Next, an available time slot in the time period is matched to availabilities, orderings, and/or priorities of interviewers and/or resources (operation 404) involved in the interviews to determine if an interviewer and/or associated resources are available during the time slot (operation 406). For example, the calendars of the interviewers and/or resources (e.g., conference rooms, interviewing tools, etc.) may be examined to identify one or more interviewers and/or resources that are available during the time slot.

If the time slot can be filled with an interview, an interviewer and/or set of resources are assigned to the time slot (operation 408) based on any orderings and/or priorities specified in constraints associated with the interviews. For example, an interviewer that is available and has higher priority and/or an earlier position in the ordering than other interviewers with availability during the time slot may be assigned to the time slot. If the constraints do not specify an ordering and/or priorities for the interviewers, the interviewer may be selected from a set of available interviewers for the time slot based on other criteria (e.g., randomly, alphabetic ordering, interviewer preferences for interview times, etc.). In another example, a conference room may be assigned to the time slot based on proximity to the interviewer, the size of the conference room, interviewing resources (e.g., projectors, computers, etc.) in the conference room, and/or other constraints. If no interviewers and/or resources are available during the time slot, scheduling of an interview in the time slot is omitted.

The interview schedule may be complete (operation 410) after the interviewer and/or resources are assigned to the time slot. For example, generation of the interview schedule may be complete after all interviews have been scheduled using operations 404-408. If the interview schedule is complete, no additional matching of time slots is required.

If the interview schedule is not complete, the matching process continues based on the ability of remaining time slots in the time period to accommodate remaining interviews (operation 412). For example, the remaining interviews can be accommodated if there are as many or more remaining time slots than remaining interviews. If the remaining time slots can accommodate the remaining interviews, operations 404-408 are repeated to match a remaining available time slot in the time period to a different interviewer and/or the same or different resources.

On the other hand, the remaining time slots cannot accommodate the remaining interviews if there are fewer remaining time slots than remaining interviews and/or interviewers or resources required to participate in the remaining interviews lack availability during the remaining time slots. In other words, the interview schedule cannot be completed with the existing set of assignments made in operations 404-408. If the interview schedule cannot be completed using the existing set of assignments, the existing assignments of interviewers and/or resources to time slots is discarded (operation 414), and subsequent attempts to generate the interview schedule may be performed until all possible assignments of interviewers and/or resources to time slots within the time period have been made (operation 416).

If operations 404-412 have not explored all permutations of assignments of interviewers and/or resources to the time slots, the matching process may restart with a first available time slot in the time period and constraints associated with the interviewers and/or resources (operations 404-408). The matching process may then proceed until the interview schedule is complete (operation 410) or the interview schedule cannot be completed using the existing assignments (operations 412-414).

If operations 404-412 have been iteratively executed to determine that the time period and/or available time slots cannot be used to schedule the interviews in a way that accommodates all constraints, the interview schedule may fail to be generated for the time period and set of constraints. Instead, operations 402-416 may be repeated with another time period to determine if the interview schedule can be generated using available time slots in the other time period. If the interview schedule cannot be generated for any time period that can be used to conduct the interviews, generation of the interview schedule using the current set of constraints may fail. One or more constraints may then be modified to facilitate generation of the interview schedule under a different set of conditions.

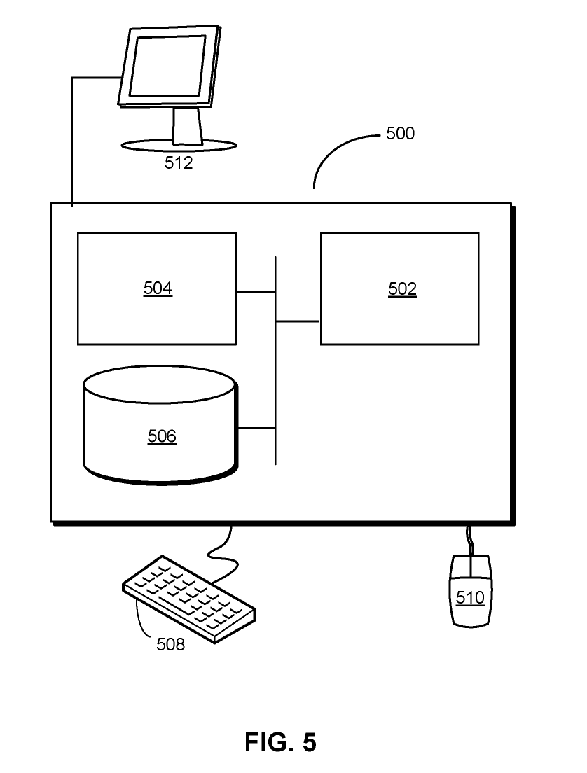

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes a matching apparatus and a scheduling apparatus, one or more of which may alternatively be termed or implemented as a module, mechanism, or other type of system component. The matching apparatus may obtain, for a set of interviews with a candidate, a set of constraints including availabilities of a set of interviewers, a set of available time slots, and a time period spanned by the set of interviews. Next, the matching apparatus may select the set of interviewers from a larger set of interviewers based on the constraints. The scheduling apparatus may then generate, using the set of constraints, an interview schedule that includes an assignment of the set of interviewers to a subset of available time slots in the time period by sequentially matching each time slot in the subset of the available time slots to the availabilities of the set of interviewers. Finally, the scheduling apparatus may schedule the set of interviews according to the interview schedule.

In addition, one or more components of computer system 500 may be remotely located and connected to the other components over a network. Portions of the present embodiments (e.g., matching apparatus, scheduling apparatus, management apparatus, data repository, request repository, etc.) may also be located on different nodes of a distributed system that implements the embodiments. For example, the present embodiments may be implemented using a cloud computing system that manages, schedules, and/or facilitates screening of candidates by a set of remote interviewers.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining, for a set of interviews with a candidate, a set of constraints comprising availabilities of a set of interviewers, a set of available time slots, and a time period spanned by the set of interviews;
generating, by a computer system using the set of constraints, an interview schedule comprising an assignment of the set of interviewers to a subset of the available time slots in the time period by sequentially matching each time slot in the subset of the available time slots to the availabilities of the set of interviewers; and
scheduling, by the computer system, the set of interviews according to the interview schedule.

2. The method of claim 1, further comprising:
selecting the set of interviewers from a larger set of interviewers based on the set of constraints.

3. The method of claim 1, wherein the set of constraints further comprises at least one of:
an ordering of the set of interviewers; and
priorities associated with the set of interviewers.

4. The method of claim 1, wherein the set of constraints further comprises an availability of a resource.

5. The method of claim 4, wherein the resource comprises at least one of:
a meeting room; and
an interviewing tool.

6. The method of claim 1, wherein the set of constraints further comprises an attribute of an interviewer.

7. The method of claim 6, wherein the attribute is at least one of:
a skill;
a level of experience;
a work history;
an education; and
a reputation score.

8. The method of claim 1, wherein generating the interview schedule further comprises:
when generation of the interview schedule cannot be completed using remaining time slots in the subset of the available time slots, restarting the sequential matching of each time slot in the subset of the available time slots to the availabilities of the set of interviewers.

9. The method of claim 1, wherein sequentially matching each time slot in the subset of the available time slots to the availabilities of the set of interviewers comprises:
when a time slot in the subset of the available time slots cannot be matched to any of the availabilities of the set of interviewers and remaining time slots in the subset of the available time slots can accommodate remaining interviewers in the set of interviewers, matching a subsequent time slot in the subset of the available time slots to the availabilities of the set of interviewers.

10. The method of claim 1, wherein generating the interview schedule further comprises:
when the interview schedule cannot be generated using the subset of the available time slots in the time period, sequentially matching each time slot in an additional subset of the available time slots in an additional time period specified in the set of constraints to the availabilities of the set of interviewers.

11. The method of claim 1, further comprising:
transmitting invitations for the scheduled set of interviews to the set of interviewers; and
updating the scheduled set of interviews based on responses to the invitations from the set of interviewers.

12. The method of claim 11, wherein updating the scheduled set of interviews based on the responses to the invitations comprises at least one of:
generating output to modify the interview schedule when a response comprises a rejection of an invitation for an interview in the scheduled set of interviews; and
when a response to an invitation is not received within a pre-specified period, generating a reminder of the invitation.

13. The method of claim 1, further comprising:
outputting the interview schedule and one or more additional interviews schedules generated from the set of constraints; and
obtaining a selection of the interview schedule prior to scheduling the set of interviews.

14. A system, comprising:
one or more processors; and
memory storing instructions that, when executed by the one or more processors, cause the system to:
obtain, for a set of interviews with a candidate, a set of constraints comprising availabilities of a set of interviewers, a set of available time slots, and a time period spanned by the set of interviews;
generate, using the set of constraints, an interview schedule comprising an assignment of the set of interviewers to a subset of the available time slots in the time period by sequentially matching each time slot in the subset of the available time slots to the availabilities of the set of interviewers; and
schedule the set of interviews according to the interview schedule.

15. The system of claim 14, wherein the memory further stores instructions that, when executed by the one or more processors, cause the system to:
select the set of interviewers from a larger set of interviewers based on the set of constraints.

16. The system of claim 14, wherein the set of constraints further comprises at least one of:
an ordering of the set of interviewers;
priorities associated with the set of interviewers;
an availability of a resource; and
an attribute of an interviewer.

17. The system of claim 14, wherein generating the interview schedule further comprises:
when generation of the interview schedule cannot be completed using remaining time slots in the subset of the available time slots, restarting the sequential matching of each time slot in the subset of the available time slots to the availabilities of the set of interviewers.

18. The system of claim 14, wherein sequentially matching each time slot in the subset of the available time slots to the availabilities of the set of interviewers comprises:
when a time slot in the subset of the available time slots cannot be matched to any of the availabilities of the set of interviewers and remaining time slots in the subset of the available time slots can accommodate remaining interviewers in the set of interviewers, matching a subsequent time slot in the subset of the available time slots to the availabilities of the set of interviewers.

19. The system of claim 14, wherein generating the interview schedule further comprises:
when the interview schedule cannot be generated using the subset of the available time slots in the time period, sequentially matching each time slot in an additional subset of the available time slots in an additional time period specified in the set of constraints to the availabilities of the set of interviewers.

20. A non-transitory computer-readable storage medium storing instructions that when executed by a computer cause the computer to perform a method, the method comprising:
obtaining, for a set of interviews with a candidate, a set of constraints comprising availabilities of a set of interviewers, a set of available time slots, and a time period spanned by the set of interviews;
generating, using the set of constraints, an interview schedule comprising an assignment of the set of interviewers to a subset of the available time slots in the time period by sequentially matching each time slot in the subset of the available time slots to the availabilities of the set of interviewers; and
scheduling the set of interviews according to the interview schedule.
